(19) United States
(12) Patent Application Publication
(10) Pub. No.: US 2007/0087317 A1
(43) Pub. Date: Apr. 19, 2007

(54) Method of providing a non-core curriculum

(76) Inventors: Paul A. Taheri, Dexter, MI (US); David A. Butz, Ann Arbor, MI (US)

Correspondence Address: CLARK HILL, P.C., 500 WOODWARD AVENUE, SUITE 3500, DETROIT, MI, 48226, US

(21) Appl. No.: 11/250,684

(22) Filed: Oct. 14, 2005

(51) Int. Cl. G09B 3/00

(52) U.S. Cl. 434/350

(57) ABSTRACT

A method for instructing a student under the direction of a director allows the student to augment his or her core curriculum with tutorials relating to a non-core curriculum such as business administration. The method uses multiple modules in specific topical areas of study. The method may be environment specific so that the student can readily identify and incorporate the non-core curriculum into practice. The non-core curriculum is designed to be appropriate for the level at which the student has obtained. In that regard, the topical areas of study and the modules are organized to introduce concepts and skills at points in the core curriculum of the student that are appropriate to help facilitate maximum absorption. A reporting mechanism will provide the student and director with valuable information regarding the performance of the student.

### BACKGROUND ART

1. Field of the Invention

The invention relates to a method for tutorials to a student body to supplement their educational experience. More particularly, the invention relates to a method for providing tutorials to students through multimedia channels for subjects peripherally related to an area of study.

2. Description of the Related Art

Students entering programs for advanced degrees are oftentimes focusing on a very specific area of study. This is especially true in programs having a curriculum centered around a professional service, e.g., medicine, law, engineering, and the like. These programs are multi-year programs requiring the students to obtain vast amounts of information in the specific field of study. In some instances, the area of study may be focused or concentrated on a very particular subject.

While these students learn and excel in the area of study, they lack an understanding of the business environment in which they are going to work. Unless these students enroll in a program for a business education, such as a masters in business administration, they may lack the skills and understanding to utilize their time and resources in an effective manner. This lack of understanding will reduce the students potential to enjoy a career in a service oriented profession by creating frustrations in the inefficiencies of the work places in which the students find themselves. The students fail at the simple task of being good stewards of the resources placed under their control.

Students in these situations find it difficult to obtain additional information regarding the business of providing services for several reasons. First, students in advanced degree programs have little time to add additional, traditional studies through organized programs. Second, students tend to lack a desire to enter new fields of study once they have completed their desired program due to a lack of motivation. After several years of studying, a student tends to wish to leave academia and enter the work force. And third, with the costs of tuition constantly rising, few students have the luxury of being able to afford multiple programs.

In the case of medicine, there is an additional incentive to advance the studies of the students. The medical field would desire the students and residents of various programs to understand basic business principles because these students and residents constitute a significant portion of the economic engine for a medical institution. Having these individuals understand the basic principles of business while they are training and completing their studies provides an economic advantage to the medical institutions. And, should the individuals be employed by those medical institutions after their education has been completed, they will be more efficient in their practices resulting in a higher return for the medical institution and a happier and more fulfilled individual.

Currently, the offerings for students of professional services in the business arena are limited. Students are left with obtaining additional degrees, attending classes in spare time, or obtaining information through periodicals and publications which they may or may not locate for their particular needs.

Therefore, there is a need for a program that provides additional training in the field of business for those students of professional services. This need would be best met by a program that can be completed concurrently with a students desired studies.

### SUMMARY OF THE INVENTION

A method for instructing a student under the direction of a director includes the steps of selecting the topical area of study. Once selected, a module of the study within the topical area of study is selected. The module of study is received electronically. Once received the module of study is transmitted through a multimedia device to be received by a student in a period of time less than or equal to forty minutes.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a flow chart of one embodiment of the inventive method;

FIG. 2 is a flow chart of a second embodiment of the invention;

FIG. 3 is a flow chart of a third embodiment of the inventive method;

FIG. 4 is a flow chart of a fourth embodiment of the inventive method; and

FIG. 5 is an example curriculum employed by the inventive method specifically designed for the medical field.

### DETAILED DESCRIPTION OF THE PREFERRED EMBODIMENT

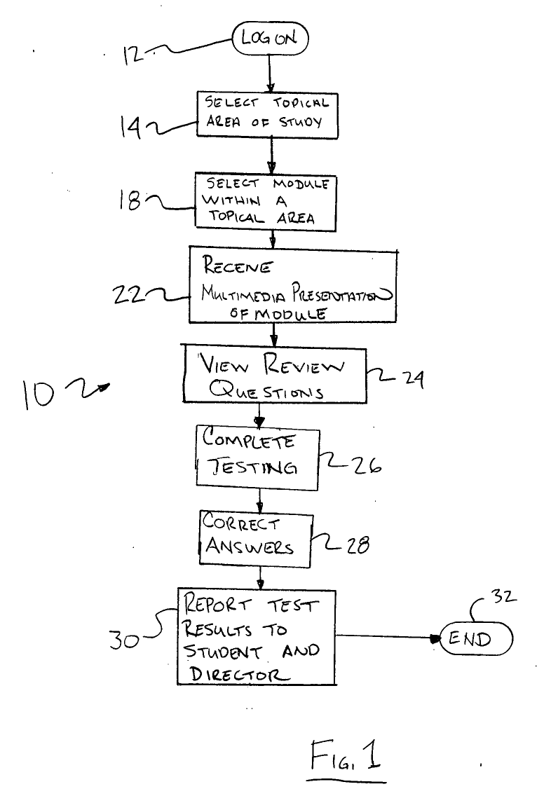

Referring to FIG. 1, one embodiment of the inventive method is generally indicated at 10. The method is a way in which a non-core curriculum may be delivered to a student allowing the student to learn from the non-core curriculum while participating in and completing his or her core curriculum. It is understood that the student will be completing his or her core curriculum under the direction of a director or counselor of some kind. The method begins at 12 with a student logging on to the system through a multimedia device. Multimedia devices may include, but are not limited to, computers, televisions, compact disk players, MP3 players, iPod®, and the like. It should be appreciated by those skilled in the art that other means of delivering multimedia content may be used.

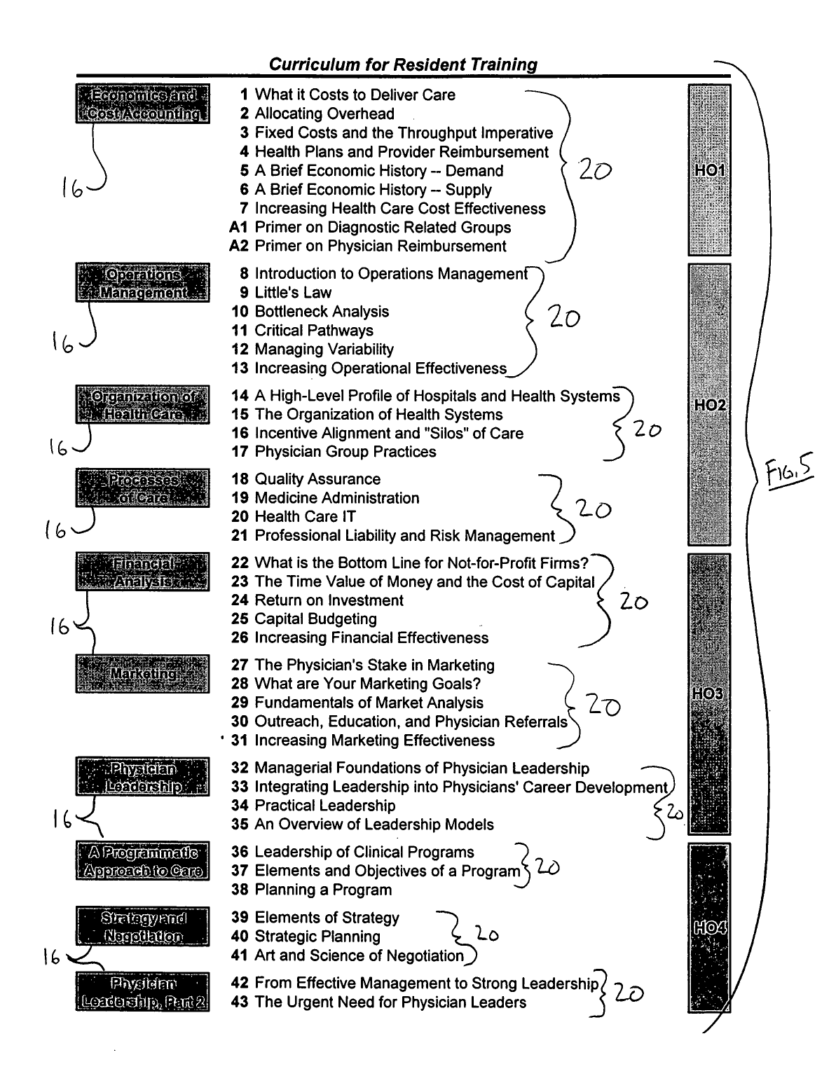

Once the student has started the method 10, the student selects a topical area of study at 14. Referring to FIG. 5, there are ten topical areas 16 identified. These topical areas 16 relate to the operation of a business in the healthcare industry. It should be appreciated by those skilled in the art that the operation of a business other. than a healthcare facility may be utilized by the inventive method 10. As is shown, the topical areas 16 may include Economics and Cost Accounting, Operations Management, Organizations Management, Organization of Healthcare, Processes of Care, Financial Analysis, Marketing, Physical Leadership, a Programmatic Approach to Care, Strategy in Negotiation, and Physician Leadership, Part Two. Other topical areas 16 may be incorporated into the curriculum and utilized by the inventive method 10.

Once a topical area 16 is selected, the student selects a module within the topical area at 18. Again returning attention to FIG. 5, there are several examples of modules 20 which may be incorporated into a particular topical area. There may be a single module 20 in a topical area 16 or there may be a plurality of modules 20 therewithin. Once a module is selected at 18, the student receives the multimedia presentation of the module at 20 at 22. As stated above, the multimedia presentation may be delivered to any device capable of presenting the module.

Because students are very busy, oftentimes juggling studies with jobs and a family, there is little hope that a student will view the entire module 20 if it is the length of a standard lecture on a particular subject. Therefore, the modules 20 are less than or equal to forty minutes in length. In the preferred embodiment, the period of time of a module 20 is approximately twenty minutes in length. The short period of time allows a student to view a module at his or her convenience with a relative certainty that a student may complete the module 20 in a single, uninterrupted period. The inventive method 10 also include the opportunity to hear or view review questions at 24. These questions are designed to facilitate a more complete understanding of the content delivered to the student by the module 20. Once completed with the review questions, the student is able to complete a test at 26. The answers to the test are corrected at 28. Once the answers are completed and corrected, a report of the test results is sent to the student and the director of the student, at 30. Because the inventive method 10 is typically given over an electronic device that provides for multi-directional communication, the report will be delivered to the student and the director almost immediately after it is generated. This will provide the proper feedback to the student and the director as to the comprehension of the content in the module 20 by the student. Once the report is delivered, the inventive method ends at 32.

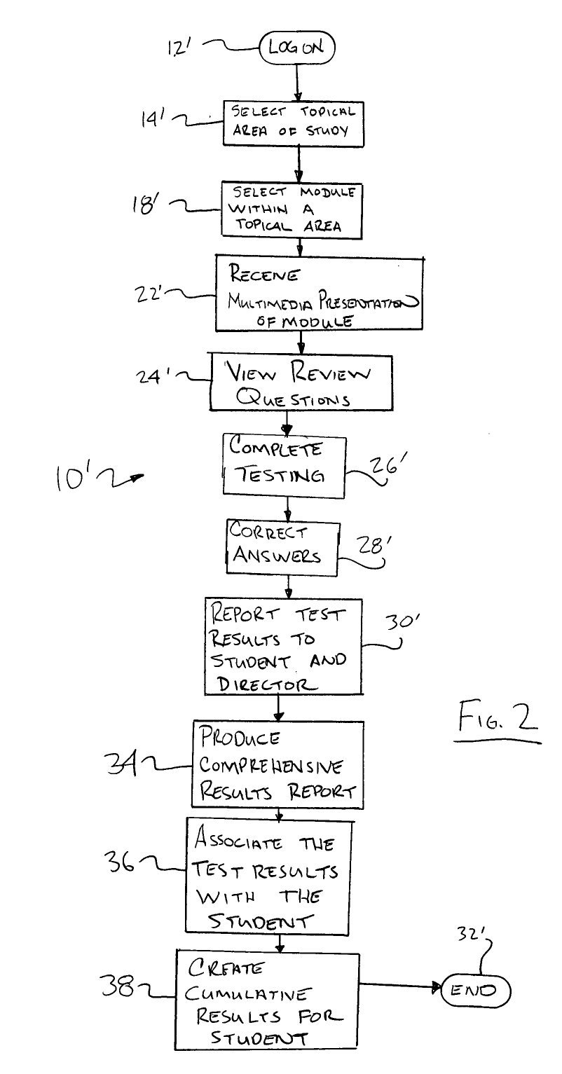

Referring to FIG. 2, wherein like prime numeral represent similar steps as those found in FIG. 1, discussed above, the inventive method 10′ begins much the same way the inventive method of the first embodiment. This second embodiment of the inventive method 10′ continues after the report test results step 30′ by producing a comprehensive results report at 34. The comprehensive results report will include information regarding all of the test results for that student up until that point. In addition, information regarding how quickly a student finishes a program may be included in the comprehensive results report. Other statistical information may include, but not limited to, statistical results relating to the students performance as compared with the rest of the class to which the student belongs, class results as compared with classes from other years or institutions, and the like. The test results are then associated with the student at 36. A cumulative results report for the student is then generated at 38. The cumulative results report will include all of the test results of all modules 20 taken by the student over the course of the program. Because this program is designed to be an augmentation to a formal curriculum, the student may complete all the modules ahead of his or her completion of the formal curriculum. Regardless, the cumulative results report will include all of the test results and be accessible by the student and the director of the student.

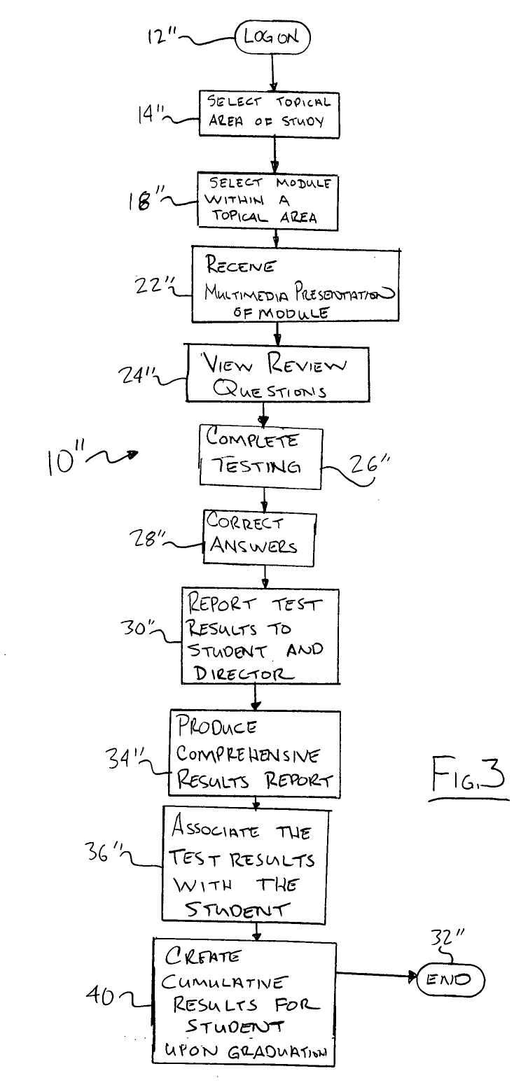

Referring to FIG. 3, a third embodiment of the inventive method 10″ is shown, wherein like double primed numerals represent similar steps as those disclosed in the first 10 and second 10′ inventive methods. The only step that is different in the third embodiment from the second embodiment is when the cumulative results test is created. In the third embodiment of the inventive method 10″, the cumulative results report is generated for the student upon graduation at 40. In this embodiment, the topical areas 16 and the modules 20 will be more structured in their application. This will result in a student completing the complete informal curriculum at the same time that the student completes the formal curriculum. This is designed to prevent a student from moving forward in the informal curriculum too quickly such that the information obtained from the latter portion of the topical areas 16 will not be as readily understood by the student until the student reaches a certain level in the student's formal curriculum. More specifically, the content of a topical area 16 and/or a module 20 and its sophistication will only be provided to a student when that topical area 16 is relevant to the student, based upon the position of the student in his or her formal curriculum. By way of example, first year residents in a medical doctorate program will not have access to leadership modules because they are not ready for those topics. First year residents are more concerned about obtaining experience and information than they are about learning how to lead a group or organization.

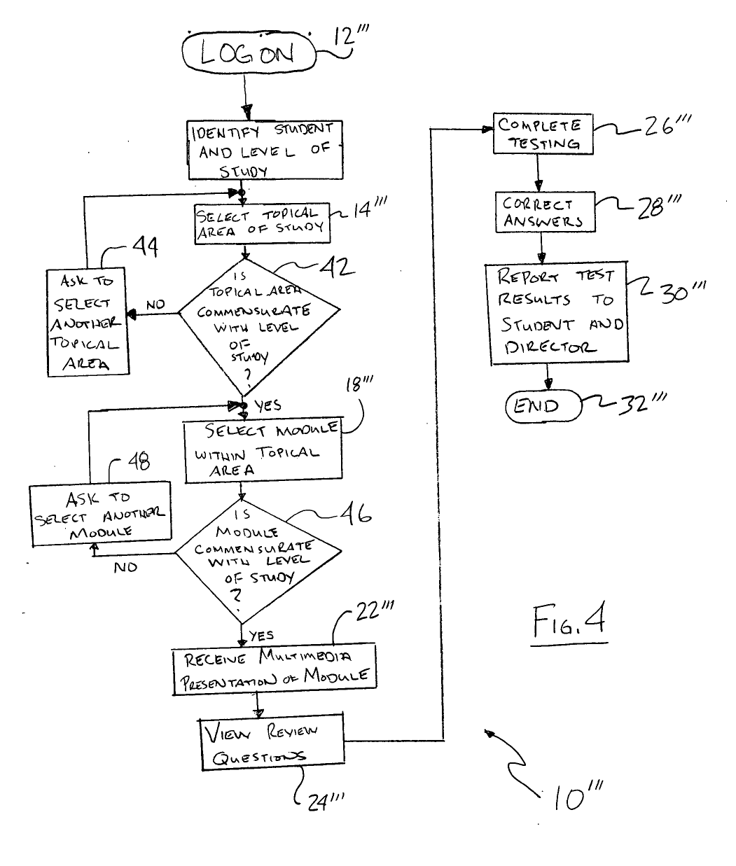

Referring to FIG. 4, wherein like triple primed numerals represent similar steps to those of the first through third embodiments, a fourth embodiment of the inventive method is generally indicated at 10′″. In this embodiment, the notion of limiting access of specific topical areas 16 and/or modules 20 is more formally controlled. Specifically, after a student selects a topical area of study at 14′″, it is then determined whether the topical area 20 is commensurate with the level of study of the student at 42. If so, the student is allowed to select a module 20 within the topical area 16 at 18′″. If not the method then asks the student to select another topical area 16 at 44. The method then loops back to provide the student the opportunity to select a topical area 16 of study at 14′″.

Likewise, when the student selects a particular module 22 within a topical area 20, at 18′″, the inventive method 10′″ determines whether the module 20 is commensurate with the level of study for the student at 46. If so, the multimedia presentation of the module 20 is presented to the student at 22′″. If not, the inventive method 10′″ asks the student to select another module 20 at 48. The method 10′″ then loops back to a point therein that allows the student to select another module 16 at 18′″.

Every topical area 16 stands on its own. Generally, this means that the student may jump ahead at any time. There are no prerequisites for the curriculum and no prerequisites for any individual topical area 16. Most modules 20 also stand on their own. Therefore, a student may take the modules 20 within a topical area 16 in any order. For that matter, the student may take the modules 20 of multiple topical areas 16 in any order. It is designed that this informal curriculum outlined in FIG. 5 will take approximately three years to complete. This will allow a resident to develop his or her business skills in tandem with his or her clinical skills. The clinical experiences will inform and reinforce the business concepts. Likewise, the business concepts will inform and reinforce the clinical experiences.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for instructing a student under the direction of a director, the method comprising the steps of:
selecting a topical area of study;
selecting a module of study within the topical area of study;
receiving the module of study electronically; and
transmitting the module of study through multimedia devices to be received by the student in a period of time less than or equal to forty minutes.

2. A method as set forth in claim 1 wherein the period of time is between twenty minutes and forty minutes.

3. A method as set forth in claim 2 including the step of presenting a plurality of test questions to the student.

4. A method as set forth in claim 3 including the step of receiving answers for the plurality of test questions.

5. A method as set forth in claim 4 including the step of correcting the answers to determine a performance of the student.

6. A method as set forth in claim 5 including the step of generating a report of the performance of the student.

7. A method as set forth in claim 6 including the step of electronically transmitting the report to the student and the director.

8. A method as set forth in claim 7 including the step of generating review questions before the step of presenting the plurality of test questions to facilitate the instructing of the student.

9. A method as set forth in claim 8 including the step of associating the report to the student.

10. A method as set forth in claim 9 including the step of collecting all reports associated with the student.

11. A method as set forth in claim 10 including the step of generating a cumulative reports based on all of the reports collected that are associated with the student.

12. A method as set forth in claim 1 including the step of identifying whether the topical area of study selected is commensurate with a level of study accomplished by the student.

13. A method as set forth in claim 12 including the step of requesting the student to select a different topical area of study when the selected topical area of study is not commensurate with the level of study accomplished by the student.

14. A method as set forth in claim 13 including the step of identifying whether the module selected is commensurate with a level of study accomplished by the student.

15. A method as set forth in claim 14 including the step of requesting the student to select a different module when the selected module is not commensurate with the level of study accomplished by the student.

16. A method for instructing a student under the direction of a director, the method comprising the steps of:
selecting a topical area of study;
selecting a module of study within the topical area of study;
receiving the module of study electronically;
transmitting the module of study through multimedia devices to be received by the student in a period of time less than or equal to forty minutes; and
generating review questions before the step of presenting the plurality of test questions to facilitate the instructing of the student.

17. A method as set forth in claim 12 including the step of presenting a plurality of test questions to the student.

18. A method as set forth in claim 13 including the step of receiving answers for the plurality of test questions.

19. A method as set forth in claim 14 including the step of correcting the answers to determine a performance of the student.

20. A method as set forth in claim 15 including the step of generating a report of the performance of the student.

21. A method as set forth in claim 16 including the step of electronically transmitting the report to the student and the director.

22. A method as set forth in claim 17 including the step of associating the report to the student.

23. A method as set forth in claim 18 including the step of collecting all reports associated with the student.

24. A method as set forth in claim 19 including the step of generating a cumulative reports based on all of the reports collected that are associated with the student.
